(19) United States
(12) Patent Application Publication
(10) Pub. No.: US 2004/0176711 A1
(43) Pub. Date: Sep. 9, 2004

(54) Massage apparatus for bowels

(76) Inventor: Moon-Seok Yang, Namjeju-Gun (KR)

Correspondence Address: DARBY & DARBY P.C., P. O. BOX 5257, NEW YORK, NY, 10150-5257, US

(21) Appl. No.: 10/485,674

(22) PCT Filed: Aug. 2, 2002
(86) PCT No.: PCT/KR02/01467

(30) Foreign Application Priority Data
Aug. 6, 2001 (KR) 2001-23820 U
Dec. 7, 2001 (KR) 2001-37807 U

(51) Int. Cl. A61H 11/00; A61H 15/00

(52) U.S. Cl. 601/84; 601/118; 601/144; 601/146

(57) ABSTRACT

A massage apparatus for bowels in a toilet seat comprising a base member, a seat member, a cover member and a water storage member comprises a motor unit having a motor therein and being disposed at the back of the base member of the toilet seat, a rotary unit having a rotation axis rotatable according to the rotation of the motor and an eccentric member eccentrically coupled to the rotation axis and extending to opposite side portions of the motor unit, a belt portion whose opposite ends being connected to the rotary unit, and an operation unit being disposed at one side portion of the base member and adjusting the on/off state and rotation speed of the motor unit. The belt portion is cut at the center and has a buckle and a tongue formed at the end of the cut portion for selectively coupling them, and a contact pad having a plurality of projections on the rear surface is formed at the center of the belt portion with the tongue so as to firmly secure the belt portion to the center of the abdomen and maximize the massaging effect.

### TECHNICAL FIELD

The present invention relates to a massage apparatus for bowels, and more particularly, to a massage apparatus for bowels which is disposed at toilet seats or chairs of various types, and which rotates or vibrates in contact with abdominal regions of a human body to provide a bowel massaging function.

### BACKGROUND ART

Typically, toilets disposed in homes, hospitals or other public facilities are provided with toilet seats of various forms to relieve oneself.

FIG. 1 is a perspective view showing a typical toilet seat. The toilet seat 10 comprises: a base member 12 being disposed to have a predetermined height from the bottom surface for making a user to relieve itself therewithin; a seat member 14 and a cover member 16 being foldably hinged to the upper portion of the base member 12, each for allowing the user to seat thereon and for enclosing the inside of the base member 12, respectively; and a water storage member 18 being formed at the upper portion of the back of the base member 12 and storing a predetermined quantity of water therewithin and supplying water within the base member 12 according to the switching operation of the user.

However, in the thusly constructed toilet seat, there is provided no fixing device useful when the user sits on the seat member formed on the upper portion of the base member. Thus it is difficult for children, elderly people and handicapped people to keep a proper seat position. Furthermore, since the conventional toilet seat cannot provide any beneficial function for constipation sufferers, they can fall victim to hemorrhoid due to a long time seating posture.

### DETAILED DESCRIPTION OF THE INVENTION

The present invention has been proposed to solve the above problems, and it is the object of the present invention to provide a massage apparatus for bowels which allows elderly people and handicapped people to keep their seated state by disposing the massage apparatus at toilet seats or chairs of various types, and which performs beneficial actions for constipation sufferers by performing bowel massaging by vibration or rotation of the massage apparatus.

### BRIEF DESCRIPTION OF THE DRAWINGS

FIG. 1 is a perspective view showing a typical toilet seat;

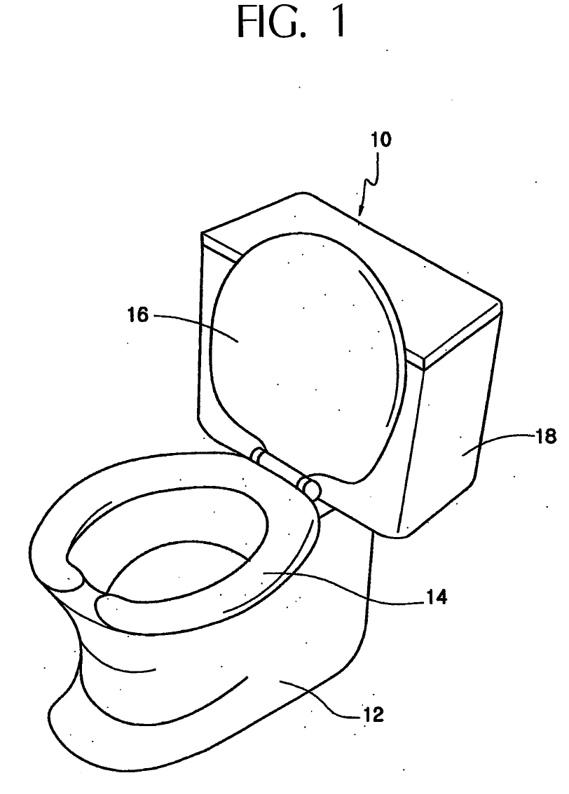

FIG. 2 is an exploded perspective view showing a massage apparatus for bowels according to a first embodiment of the present invention;

FIG. 3 is a view showing the massage apparatus for bowels according to the first embodiment of the present invention when it is used;

FIG. 4 is a perspective view showing a massage apparatus for bowels according to a second embodiment of the present invention;

FIG. 5 is a perspective view showing a massage apparatus for bowels according to a third embodiment of the present invention;

FIG. 6a is an exploded perspective view showing a massage apparatus for bowels according to a fourth embodiment of the present invention;

FIG. 6b is a plane view showing the massage apparatus for bowels according to the fourth embodiment of the present invention;

FIG. 7 is a view showing the massage apparatus for bowels according to the fourth embodiment of the present invention when it is used;

FIG. 8 is an exploded perspective view showing a massage apparatus for bowels according to a fifth embodiment of the present invention;

FIG. 9a is an exploded perspective view showing a massage apparatus for bowels according to a sixth embodiment of the present invention;

FIG. 9b is a plane view showing the massage apparatus for bowels according to the sixth embodiment of the present invention;

### MODES FOR CARRYING OUT THE INVENTION

The present invention will be described in more detail with reference to the accompanying drawings.

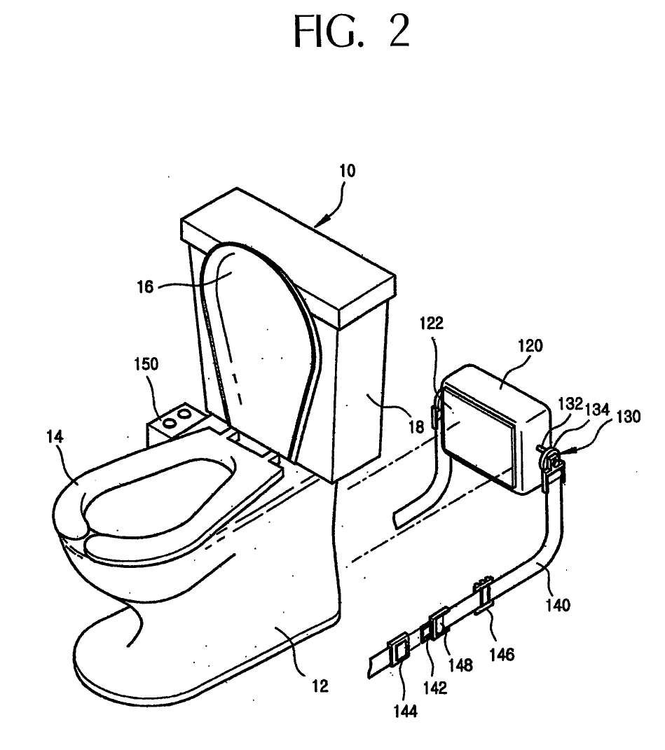

Firstly, FIG. 2 is a perspective view showing a massage apparatus for bowels according to a first embodiment of the present invention. According to the first embodiment of the present invention, a toilet seat 10 having a base member 12, a seat member 14 and cover member 16 and a water storage member 18 is equipped with a massage apparatus for bowels including a motor unit 120, a rotary unit 130, a belt portion 140 and an operation unit 150 so as to safely secure the body of a user to the base member 12 and perform massaging on abdominal regions of the body.

Here, the motor unit 120 is formed at the back of the base member 12 of the toilet seat 10 or near the water storage member 18. It has a motor provided within a rectangular housing having a predetermined strength and rotated by a predetermined power. At opposite sides of the motor is disposed the rotary unit 130 including a rotation axis 132 protruded outwardly of the housing and an eccentric member 134 eccentrically coupled to the rotation axis 132 and integrally rotated by the rotation force of the motor transmitted from the rotation axis 132.

Additionally, at a portion where the housing constituting the motor unit 120 is contacted with the base member 12 or the water storage member 18 of the toilet seat 10, is formed a vibration absorbing member 122 having a predetermined elastic force for absorbing vibration generated upon operation of the motor. To the rotary unit 130 formed at opposite sides of the motor unit 120 is coupled one end of the belt portion 140. The belt portion 140 is preferably made of flexible material having a predetermined strength. At the other end of the belt portion 140, whose one end being coupled to the rotary unit 130, are formed respectively a tongue 142 and a buckle 144 for allowing selective coupling.

Meanwhile, for allowing the belt portion 140 to be selectively coupled, it is also possible to attach a Velcro tape (not shown) having a loop surface and a hook surface in order to reduce manufacturing cost. Onto the end of the belt portion 140 is coupled a laterally movable contact pad 146 having a plurality of projections on the back surface, thereby firmly holding the belt portion 140 against the center portion of the abdomen and at the same time doubling the bowel massaging function.

Moreover, at one side portion of the base member 12 of the toilet seat 10 is provided an operation unit 150 for selectively driving the motor unit 120. The operation unit 150 includes an on/off switch for controlling the power supply to the motor unit 120, a vibration strength adjusting unit for adjusting the strength of vibration transmitted from the belt portion 140 by adjusting the rotation force of the motor in the motor unit 120, and a timer for adjusting the operation time of the motor unit 120.

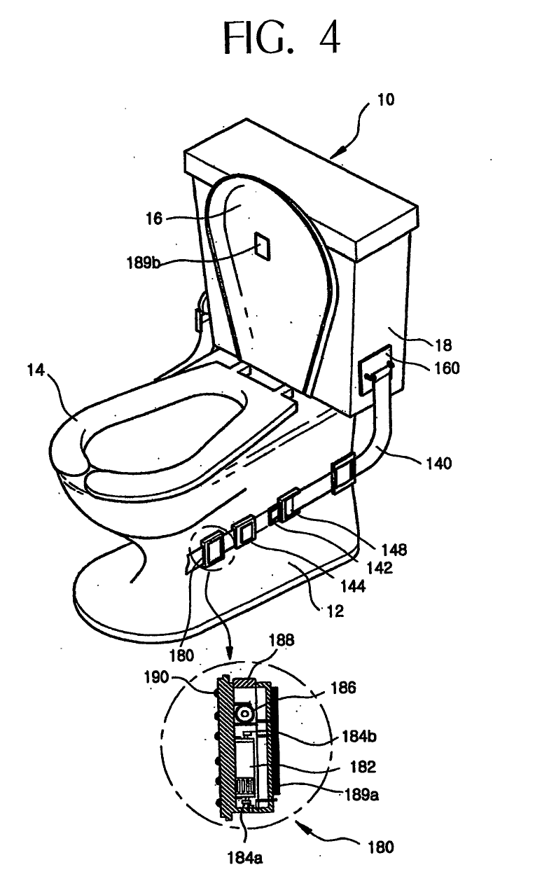

FIG. 4 is a perspective view showing a massage apparatus for bowels according to a second embodiment of the present invention. According to the second embodiment of the present invention, it is also possible to construct the massage apparatus for bowels by firmly holding the belt portion 140 coupled integrally to the vibration member 180 against the toilet seat 10 or the like. As described above, at the other end of the belt portion 140 having the tongue 142 and the buckle 144 at one end is disposed an adhesion member 160 having a strong adhesion force. The adhesion member 160 is secured to a predetermined portion of the base member 12, cover member 16 or water storage member 18 of the toilet seat 10. In this state, the vibration member 180 is coupled to the belt portion 140 having the buckle 144, whereby the massage apparatus for bowels of the present invention can be constructed at the toilet seat or the like.

Here, the vibration member 180 is constructed by having a vibration motor 182 with a plurality of vibrators 184a and 184b and a power source unit 186 having a battery for supplying a power to the vibration motor 182 within the broad, rectangular housing. On the upper surface of the housing is disposed an operation unit 188 having an on/off switch, a vibration strength adjusting unit and a timer for selectively supplying a power from the battery to the vibration motor 182.

Furthermore, on the back surface of the housing of the vibration member 180 where a human body is contacted, a plurality of projections 190 are formed to thus perform a finger pressure action and maximize abdomen and bowel massaging effects. At a position adjacent to the tongue 142 of the belt portion 140 is formed a length adjusting member 148 for thereby properly adjusting the length of the belt portion 140 according to the body shape of the user.

Additionally, on the front surface of the housing of the vibration member 180 is formed a Velcro tape 189a having a loop surface and a hook surface. By forming a Velcro tape 189b corresponding to the Velcro tape 189a on the inner surface of the cover member 16 of the toilet seat 10, the Velcro tapes 189a and 189b can be coupled with each other and be stored conveniently when the vibration member 180 is not in use. Also, the vibration member 180 may be constructed to perform a massaging action on the back portion of the body when actuated in the state of being held to the cover member 16.

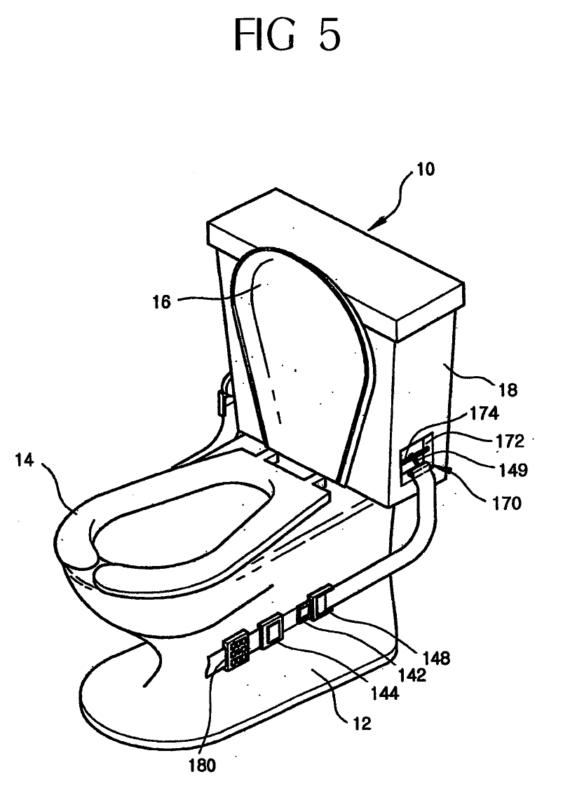

Meanwhile, FIG. 5 is a perspective view showing a massage apparatus for bowels according to a third embodiment of the present invention. The belt portion 140 formed integrally with vibration member 180 as shown in FIG. 5 is coupled to the toilet seat 10 or the like in the following manner. A coupling portion 170 is constructed by forming a concave portion 172 recessed to a predetermined depth at opposite sides of the water storage member 18 of the toilet seat 10 and forming a rod-type fixing member 174 transversely or longitudinally crossing the concave portion 172 above the concave portion. In this state, a latching member 149 selectively coupled to and withdrawn from the fixing member 174 is formed at the other end of the belt portion 140 having the tongue 142 and the buckle 144 at one end, whereby the belt portion 140 coupled with the vibration member 180 can be coupled to the toilet seat or the like.

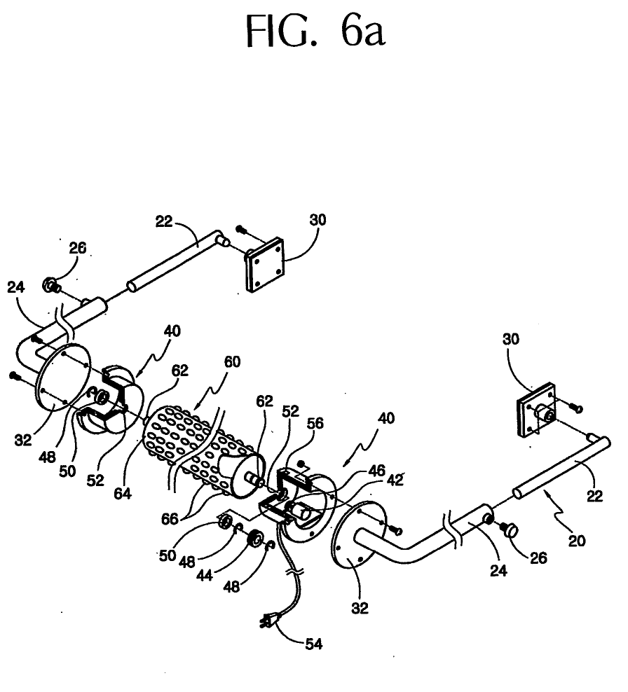

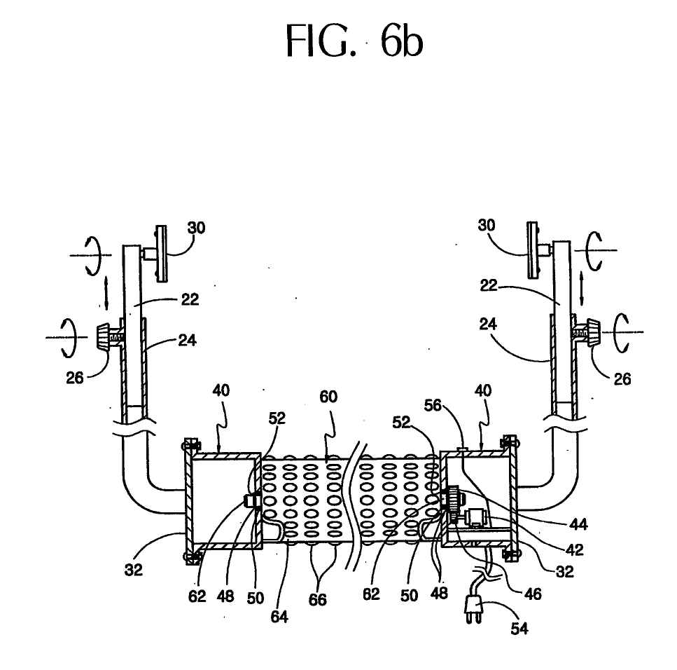

Meanwhile, FIG. 6a is an exploded perspective view showing a massage apparatus for bowels according to a fourth embodiment of the present invention; and FIG. 6b is a plane view showing the massage apparatus for bowels according to the fourth embodiment of the present invention. As described above, according to the fourth embodiment of the present invention, a massage apparatus for providing a bowel massaging function to a user is disposed at toilet seats or chairs of various types including a base member, a seat member, a cover member and a water storage member. The massage apparatus for bowels includes a pair of coupling members 20 for holding the bowel massage apparatus against the toilet seats or chairs of various types, a rotary member 60 being rotated in contact with abdominal regions of the body and performing a bowel massaging action and a pair of connecting members 40 connecting the coupling member 20 and the rotary member 60 and having various devices for actuating the rotary member 60 therein.

Here, the coupling member 20 includes a first coupling member 22 and a second coupling member 24. The first coupling member 22 is constructed such that it can have a vertically rotatable structure by making the fixing member 30 rotatably coupled to one end thereof and attaching the fixing member 30 to opposite sides of the toilet seats or chairs of various types using a Velcro tape or adhesive tape or fixing it thereto by a screw. At the other end of the first coupling member 22 is coupled one end of the second coupling member 24 having a certain space portion therewithin. The length of the coupling member 20 can be selectively adjusted by inserting or withdrawing the other end of the first coupling member 22 into or from the space portion of the second coupling member 24 and thereafter engaging and fixing a pressure member 22. Meanwhile, at the other end of the second coupling member 24 is formed a coupling plate 32 of a disc type, thereby making the connecting member 40 coupled to the second coupling member 24 through the coupling plate 32.

The connecting member 40 is formed in a cylindrical shape whose one side portion is opened. The opened portion is fixedly coupled to the coupling plate 32 by a bolt and a nut. Within the connecting member 40, is formed a motor unit 42 for generating a certain power by a certain power supply applied from the outside. On the axis of the motor unit 42 is formed a main gear 46 for transmitting the power from the motor unit 42. The outer circumferential surface of the main gear 46 meshes with the outer circumferential surface of a sub gear 44 into which the axis of the rotary member 60 is coupled. A withdrawal preventing member 48 is coupled in front and at the back of the sub gear 44, respectively, for thereby transmitting the power generated from the motor unit 42 to the rotary member 60 through the main gear 46 and the sub gear 44.

Meanwhile, on the other side surface is punched a coupling hole 52 for insertingly coupling the axis of the rotary member 60. Thereafter, a bearing 50 is formed within the coupling hole 52 for thereby smoothly rotating the rotary member 60. Furthermore, on the outer circumferential surface of the connecting member 40 is formed a power source unit 54 being connected to the motor unit 42 and supplying a power from the outside to the motor unit 42. Additionally, a switch unit 56 is formed thereon for thereby selectively applying a power to the power source unit 54 and adjusting the rotation speed and rotary direction of the motor unit 42.

The rotary member 60 is formed in a cylindrical shape having a predetermined length. On the outer circumferential surface thereof is selectively coupled a finger pressure member 64, whereby a plurality of finger pressure projections 66, being protruded to the outer surface of the finger pressure member 64, pressurize abdominal regions and resultantly strengthen the bowel massage function. Meanwhile, at opposite ends of the rotary member 60 is formed a coupling projection 62 constituting the axis thereof. The rotary member 60 is rotated in conjunction with the sub gear 44 according to the rotation of the motor unit 42 by coupling the coupling projection 62 integrally with the inner circumferential surface of the sub gear 44 through the bearing 50 formed on the coupling hole 52 of the connecting member 40.

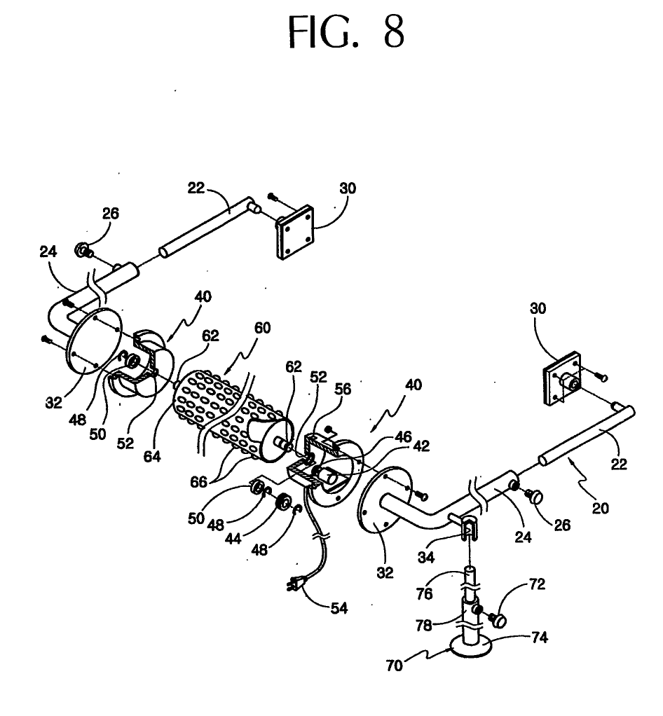

FIG. 8 is an exploded perspective view showing a massage apparatus for bowels according to a fifth embodiment of the present invention. By selectively coupling a supporting member 70 to a predetermined position of the coupling member 20, the bowel massage apparatus can be constructed such that it operates in the state of being fixed to the bottom surface more stably. In order to couple the supporting member 70 thereto, an insertion recess portion 34 is formed at a certain portion of the second coupling member 24 at one side of the coupling member 20, the insertion recess portion 34 being opened toward the lower side so that it can be coupled to the supporting member 70. The supporting member 70 includes an upper member 76 and a lower member 78 so as to adjust the height thereof. The supporting member 70 can be engaged and fixed by a pressure member as the upper member 76 is inserted into or withdrawn from the lower member 78. At the lower end of the lower member 78 is formed a supporting plate 74 of a disc type to firmly secure the supporting member 70 to the bottom surface.

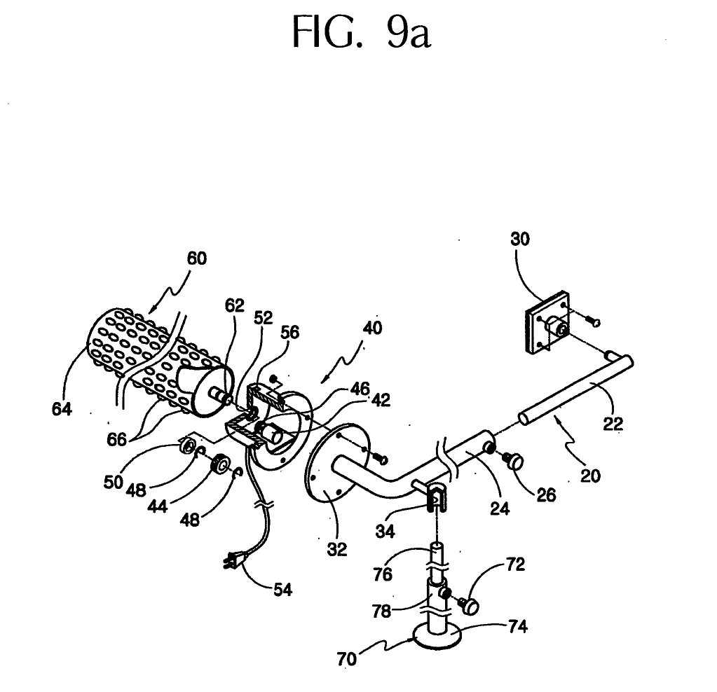

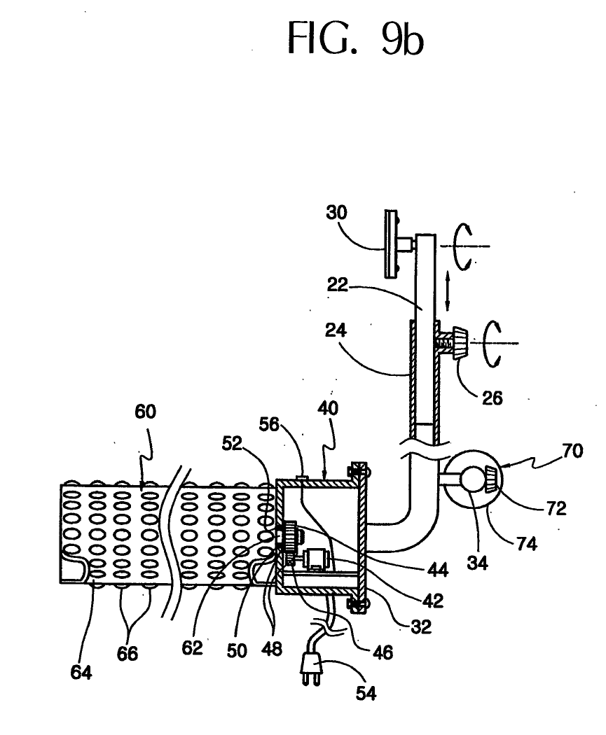

Additionally, according to the sixth embodiment of the present invention as shown in FIGS. 9a and 9b, the coupling member 20 is coupled to only one side portion of the toilet seat or chair by the fixing member 30 and then the bowel massage apparatus is supported on the bottom surface by the above-described supporting member 70. At the other end of the coupling member 20 is coupled a connecting member 40 having a motor unit 42, a main gear 46, a sub gear 44, a power source unit 54 and a switch unit 56. At the connecting member 40 is coupled the rotary member 60 having a coupling projection 62 at one end. Consequently, the bowel massaging action can be performed on abdominal regions of the body as the rotary member 60 rotates according to the operation of the motor unit 42.

Moreover, the massage apparatus for bowels according to the present invention is provided with a melody device therein for outputting a variety of melody sounds such as children's songs, classical music and the like during the operation of the massage apparatus for bowels. Thus, when the massage apparatus for bowels is used by children, it can help them in forming a proper behavior in the use of toilets as well as giving them emotional peace. At the same time, when used by adults, it can alleviate boredom during evacuation.

The operation of the thus constructed apparatus of the present invention will be described in detail with reference to the accompanying drawings.

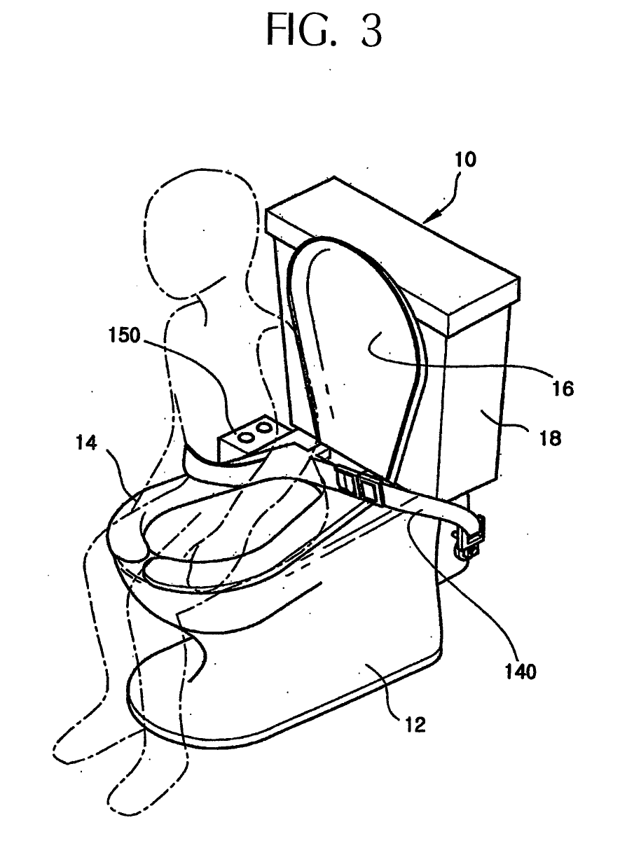

FIG. 3 is a view showing the massage apparatus for bowels according to the first embodiment of the present invention when it is used. To use the massage apparatus for bowels according to the first embodiment of the present invention as shown in FIG. 2, as described above, the motor unit 120, the rotary unit 130, the belt portion 140 and the operation unit 150 are disposed at the toilet seat 10 including the base member 12, the seat member 14, the cover member 16 and the water storage member 18. In this state, the user sits himself or herself on the seat member 14 of the toilet seat.

Sitting on the seat member 14, the user adjusts the belt portion 140 coupled to opposite sides of the motor unit 120 to an appropriate length. Then the buckle 144 and the tongue 142 of the belt portion 140 are coupled, and the central portion of the coupled belt portion 140 and the contact pad 146 are contacted to the center of the abdomen of the user, for example, to umbilical regions.

Therefore, the body sitting on the toilet seat 10 is confined in the belt portion 140 and is prevented from departing from the toilet seat 10. Consequently, elderly people, handicapped people and patients suffering from diseases or accidents can use the toilet seat 10 safely.

Moreover, as describe above, when the user, who is wearing the belt portion 140, turns on the on/off switch of the operation unit 150 formed at one side portion of the base member 12, the motor unit 120 is operated by a power and the rotation force thereof is transmitted to the rotary unit 130 having a rotation axis 132 and an eccentric member 134. Accordingly, the vibration generated through the eccentric member 134 is transmitted to the belt portion 140 connected with the rotary unit 130 and an massaging effect is given to the abdominal regions and bowels of the body wearing the belt portion 140, thereby performing beneficial actions for constipation sufferers.

At this time, the user can use the massage apparatus for bowels more efficiently while operating the vibration strength adjusting unit and timer of the operation unit 150.

Additionally, in order to use the massage apparatus for bowels according to the second and third embodiments of the present invention, as shown in FIGS. 4 and 5, the belt portion 140 is firmly coupled to a predetermined portion of the toilet seat 10 by using the adhesive member 160 formed on one end of the belt portion 140 and the water storage member 18 of the toilet seat 10. In this state, the user sits on the seat member 12 of the toilet seat 10, and then allows the body to be secured onto the toilet seat 10 by means of the belt portion 140 by coupling the tongue 142 and the buckle 144 of the belt portion 140.

Continuously, the vibration member 180 coupled to the belt portion 140 at one opposite side is positioned at the center of the abdomen of the body. In this state, when the on/off switch of the operation unit 188 formed on the upper surface of the vibration member 180 is turned on, the power from the battery provided in the vibration member 180 is transmitted to the vibration motor 182. Hence, the vibration generated from the vibration motor 182 and the plurality of vibrators 184a and 184b is transmitted to abdominal regions contacting the belt portion 140 and the vibration member 180.

Hence, the massaging action can be performed on abdominal regions and bowels of the body by means of the vibration member 180 and the belt portion 140. Meanwhile, a plurality of projections 190 are formed on the back surface of the belt portion 140 and the vibration member 180, thereby maximizing the abdomen and bowel massaging effects as described above.

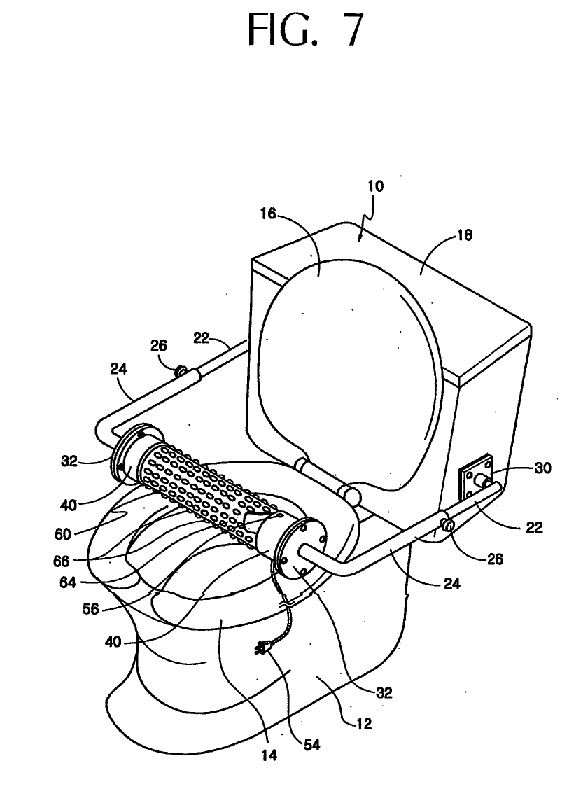

FIG. 7 is a view showing the massage apparatus for bowels according to the fourth embodiment of the present invention when it is used. Firstly, in order to use the massage apparatus for bowels according to the fourth embodiment of the present invention as shown in FIGS. 6a and 6b, the fixing member 30 formed at the end of the first coupling member 22 of the pair of coupling members 20 is attached or screwed to opposite side surfaces of the water storage member 18 of the toilet seat 10, thereby fixing the massage apparatus for bowels.

Sat on the seat member 14 of the toilet seat 10, the user of the bowel massage apparatus rotates the coupling member 20 rotatably formed on the fixing member 30 in a downward direction, so that the rotary member 60 can be positioned in front of the abdomen. In this state, the first coupling member 22 of the coupling member 20 is inserted into the second coupling member 24 to a proper length and the pressure member 26 is engaged thereto, thus making the rotary member 60 contact abdominal regions.

Additionally, as a power is applied to the motor unit 42, the motor unit 42 generates a certain power to thus rotate the main gear 46 coupled to the axis thereof. Resultantly, the sub gear 44 meshing with the main gear 46 is rotated and at the same time the rotary member 60, which has the coupling projection 62 constituting the axis thereof coupled to the inner circumferential surface of the sub gear 46 through the bearing 50 formed on the coupling hole 52 of the connecting member 40, is rotated by the power of the motor unit 42. Therefore, the massaging effect is given to abdominal and bowel regions of the user sitting on the toilet seat 10.

At this time, the user can change the rotational direction of the rotary member 60 to the forward direction or the backward direction by operating the switch unit 56 formed on the connecting member 40. Also, the massaging effect can be maximized by adjusting the rotation speed of the rotary member 60.

Furthermore, when the bowel massage apparatus is not in use, the coupling member 20 rotatably coupled to the fixing member 30 is moved upwardly to make the bowel massage apparatus positioned above the water storage member 18 of the toilet seat 10. By this, the bowel massage apparatus can be prevented from being an obstacle in using the toilet seat 10.

Meanwhile, when in use of the bowel massage apparatus according to the fifth and sixth embodiments of the present invention as shown in FIGS. 8, 9a and 9b, the rotary member 60 comes into close contact with abdominal regions of the user by adjusting the first and second coupling members 22 and 24 of the coupling member 20. In this state, the length of the supporting member 70 is properly adjusted by using the upper member 76, lower member 78 and pressure member 72 of the supporting member 70, and then the supporting plate 74 formed on the lower end thereof is supported on the bottom surface, whereby the bowel massage apparatus can be operated while being more firmly fixed to the bottom surface.

### Industrial Applicability

According to the present invention constructed as described above, the massaging action can be performed on abdominal and bowel regions of the user sitting on the seat surface by disposing the bowel massage apparatus at toilet seats or chairs of various types in toilets of homes, hospitals and other public facilities, whereby very beneficial actions can be performed on the body of the user, for example, a constipation sufferer.

Furthermore, the bowel massage apparatus can prevent the body of elderly people, handicapped people and patients from departing from the toilet seat. Also, it can make them keep a proper sitting position on the toilet seat.

What is claimed is:

1. A massage apparatus for bowels in a toilet seat including a base member, a seat member, a cover member and a water storage member comprising: a motor unit having a motor therein and being disposed at the back of the base member of the toilet seat; a rotary unit having a rotation axis rotatable according to the rotation of the motor and an eccentric member eccentrically coupled to the rotation axis and extending to opposite side portions of the motor unit; a belt portion whose opposite ends being connected to the rotary unit, and an operation unit being disposed at one side portion of the base member; and adjusting the on/off state and rotation speed of the motor unit,
wherein the belt portion is cut at the center and has a buckle and a tongue formed at the end of the cut portion for selectively coupling them, and a contact pad having a plurality of projections on the rear surface is formed at the center of the belt portion with the tongue so as to firmly secure the belt portion to the center of the abdomen and maximize the massaging effect.

2. A massage apparatus for bowels disposed in a toilet seat including a base member, a seat member, a cover member and a water storage member comprising:
a belt portion having a tongue and a buckle at one end and an adhesive member secured to a predetermined portion of the base member, the cover member or the water storage member at the other end; and
a vibration member having a vibration motor, a power source unit and an operation unit, the vibration motor being coupled to the center of the belt portion with the buckle, being shaped in a rectangular and having vibrators therein, the power source unit applying a power to the vibration motor, and the operation unit selectively applying a power to the power source unit and adjusting the strength of the vibration motor.

3. The apparatus of claim 2, wherein a plurality of projections for performing finger pressure action are formed on the rear surface of the vibration member contacting the body of a user wearing the belt portion and a length adjusting member is formed at a portion adjacent to the tongue of the belt portion for adjusting the length of the belt portion according to the body shape of the user.

4. The apparatus of claim 2, wherein a Velcro tape having a loop surface and a hook surface is formed on the front surface of the vibration member and a Velcro tape corresponding to that formed on the vibration member is formed on the inner surface of the cover member, so as to selectively secure the vibration member to the cover member and store the same or perform the massaging action on the back portion of the body.

5. A massage apparatus for bowels disposed in a toilet seat including a base member, a seat member, a cover member and a water storage member comprising:
a coupling portion having a concave portion recessed to a predetermined depth at opposite side portions of the water storage member of the toilet seat and a fixing member of a rod shape coupled to the concave portion transversely or longitudinally;
a belt portion having a tongue and a buckle at one end and a latching member at the other end so as to be selectively confined and coupled to the fixing member of the coupling portion; and
a vibration member having a vibration motor, a power source unit and an operation unit, the vibration motor being coupled to the center of the belt portion with the buckle, being shaped in a rectangular and having vibrators therein, the power source unit applying a power to the vibration motor, and the operation unit selectively applying a power to the power source unit and adjusting the strength of the vibration motor.

6. A massage apparatus for bowels, which is disposed at toilet seats or chairs of various types so that a user sitting on the seat surface can perform bowel massaging, comprising:
a coupling member having a fixing member for fixing the bowel massage apparatus to the toilet seat or chair at one end so as to allow the one end to be rotatably coupled to the fixing member and adjust the length;
a motor unit generating a power applied from the outside and rotating the axis thereof with its body being fixed to the other end of the coupling member; and
a rotary member being formed in a cylindrical shape of a predetermined length, being coupled to the axis of the motor unit and rotating in conjunction with the rotation of the motor unit.

7. The apparatus of claim 6, wherein the coupling member comprises a first coupling member and a second coupling member, and a pressure member is engaged and fixed to the coupling member by adjusting the length of the coupling member while selectively inserting or withdrawing the first coupling member into the second coupling member.

8. The apparatus of claim 6, wherein the motor unit is formed within the coupling member whose one side portion is coupled to the coupling plate formed at the other end of the coupling member, a main gear for transmitting the rotation force of the motor unit to the rotary member is formed on the axis of the motor unit, the main gear meshing with a sub gear coupled to the axis of the rotary member, and a power source unit for applying a power to the motor unit and a switch unit for selectively operating the motor unit are formed at the outside of the connecting member.

9. The apparatus of claim 6, wherein a supporting member supporting the bottom surface is vertically coupled to the coupling member at one side so as to fix the bowel massage apparatus at a proper height for use.

10. The apparatus of claim 6, wherein a finger pressure member of a cylindrical shape is selectively coupled to the outer circumferential surface of the rotary member, whose opposite sides are opened and which has a plurality of projections protruded on the outer surface for maximizing the bowel massaging effect.
